(19) United States
(12) Patent Application Publication
(10) Pub. No.: US 2012/0250246 A1
(43) Pub. Date: Oct. 4, 2012

(54) DOCKING STATION AND ELECTRONIC APPARATUS

(75) Inventor: Yuji NAKAJIMA, Nishitama-gun (JP)

(73) Assignee: KABUSHIKI KAISHA TOSHIBA, Tokyo (JP)

(21) Appl. No.: 13/347,038

(22) Filed: Jan. 10, 2012

(30) Foreign Application Priority Data
Mar. 31, 2011 (JP) 2011-078679

(51) Int. Cl. G06F 1/16

(52) U.S. Cl. 361/679.41

(57) ABSTRACT

According to one embodiment, a docking station includes a housing, a connecting part, and a positioning part. The housing includes a placing part on which apparatuses of various types are placed. The connecting part is provided in the placing part, and connected to the apparatuses in common. The positioning part is capable of projecting from the placing part in a first place and a second place. The positioning part in the first place is adjacent to an edge part of one of the apparatuses and guides the apparatus to a position where the apparatus is connected to the connecting part. The positioning part in the second place is adjacent to an edge part of another one of the apparatuses and guides the another apparatus to a position where the another apparatus is connected to the connecting part. The another apparatus has a different size from that of the apparatus.

### CROSS-REFERENCE TO RELATED APPLICATIONS

This application is based upon and claims the benefit of priority from prior Japanese Patent Application No. 2011-078679, filed Mar. 31, 2011, the entire contents of which are incorporated herein by reference.

### FIELD

Embodiments described herein relate generally to a docking station and an electronic apparatus.

### BACKGROUND

Apparatuses such as portable computers may be connected to an extension apparatus such as a port replicator. Port replicators include a plurality of types of terminals, thereby extend a function of a portable computer, facilitate connection and disconnection of a plurality of cables, and supply power to the connected portable computer.

Port replicators may be compatible with a plurality of types of portable computers. In this case, the sizes of the portable computers and positions of connectors differ according to the types of the portable computers. Therefore, positioning of the portable computer when the portable computer is connected to the port replicator is difficult, and a connector may be damaged during connection work.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view illustrating a port replicator and a first portable computer according to a first embodiment;

FIG. 2 is an exemplary plan view illustrating the port replicator of the first embodiment;

FIG. 3 is an exemplary cross-sectional view of the port replicator of the first embodiment, which is taken along line F3-F3 of FIG. 2;

FIG. 4 is an exemplary cross-sectional view of the port replicator according to the first embodiment, in a state where first movable parts are concealed;

FIG. 5 is an exemplary cross-sectional view of the port replicator of the first embodiment, which is taken along line F5-F5 of FIG. 2;

FIG. 6 is an exemplary perspective view of the port replicator in a state where the first movable parts and a second movable part are displaced to a first position in the first embodiment;

FIG. 7 is an exemplary plan view of the port replicator, which is connected to a second portable computer, in the first embodiment;

FIG. 8 is an exemplary plan view of the port replicator, which is connected to a third portable computer, in the first embodiment;

FIG. 9 is an exemplary plan view of the port replicator, which is connected to a fourth portable computer, in the first embodiment;

FIG. 10 is an exemplary perspective view illustrating a cradle, a slate computer, and a mobile phone, according to a second embodiment;

FIG. 11 is an exemplary perspective view illustrating a port replicator according to a third embodiment;

FIG. 12 is an exemplary perspective view illustrating a port replicator according to a fourth embodiment;

FIG. 13 is an exemplary perspective view illustrating a port replicator according to a fifth embodiment; and

FIG. 14 is an exemplary cross-sectional view of the port replicator according to the fifth embodiment, which is taken along line F14-F14 of FIG. 13.

### DETAILED DESCRIPTION

Various embodiments will be described hereinafter with reference to the accompanying drawings.

In general, according to one embodiment, a docking station includes a housing, a connecting part, and a positioning part. The housing includes a placing part on which apparatuses of various types are placed. The connecting part is provided in the placing part, and connected to the apparatuses in common. The positioning part is capable of projecting from the placing part in a first place and a second place. The positioning part in the first place is adjacent to an edge part of one of the apparatuses and guides the apparatus to a position where the apparatus is connected to the connecting part. The positioning part in the second place is adjacent to an edge part of another one of the apparatuses and guides the another apparatus to a position where the another apparatus is connected to the connecting part. The another apparatus has a different size from that of the apparatus.

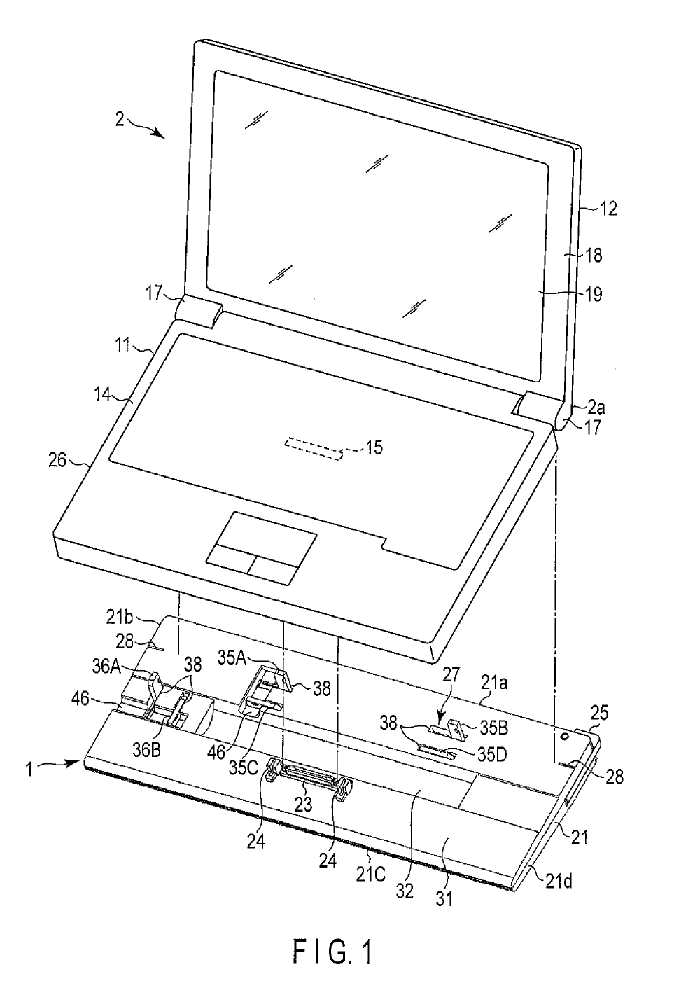

The following is an explanation of a first embodiment with reference to FIG. 1 to FIG. 9. In the present specification, the user side is defined as the front, a side distant from the user is defined as the rear, the left side as viewed from the user is defined as the left, the right side as viewed from the user is defined as the right, the upper side as viewed from the user is defined as the upper side, and the lower side as viewed from the user is defined as the lower side.

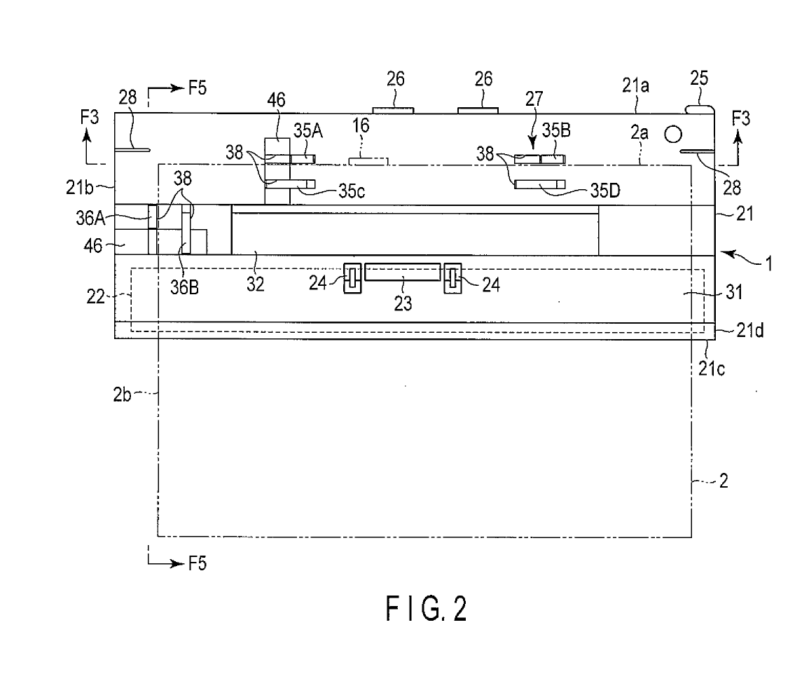

FIG. 1 is a perspective view illustrating a port replicator 1 and a first portable computer 2, according to the first embodiment. FIG. 2 is a plan view illustrating the port replicator 1. In FIG. 2, the first portable computer 2 is illustrated by two-dot chain lines. The port replicator 1 is an example of an electronic apparatus and a docking station. The docking station is an extension device which is connected to, for example, a personal computer. The first portable computer 2 is an example of one apparatus.

As illustrated in FIG. 1, the first portable computer 1 docks in the port replicator 1. The first portable computer 2 comprises a main unit 11, and a display unit 12.

The main unit 11 includes a PC housing 14 which has a flat box shape. An upper surface of the PC housing 14 is provided with a keyboard, a palm rest, a touch pad, and a pair of click buttons. In FIG. 1, keys of the keyboard are omitted.

A bottom surface of the main unit 11 is provided with a first connector 15, a pair of holes, and a ground electrode. In FIG. 1, the first connector 15 is illustrated by a broken line. The first connector 15 connects the port replicator 1 with the first portable computer 2. The holes are located on either side of the first connector 15.

As illustrated by two-dot chain lines in FIG. 2, a plurality of terminals 16 are provided on an outer edge of the main unit 11. In other words, a plurality of terminals 16 are provided on a rear edge part 2a of the first portable computer 2. The terminals 16 are, for example, a USB connector and an RGB connector. A left edge part 2b of the first portable computer 2 is also provided with a terminal such as a USB connector.

The touch pad of the main unit 11 is located in line with a space key of the keyboard. Therefore, the touch pad is located closer to the left edge part 2b of the first portable computer 2. In line with this, the first connector 15 is located closer to the left edge part 2b of the first portable computer 2.

As illustrated in FIG. 1, the display unit 12 is connected to a rear end of the main unit 11, through a pair of hinge parts 17. The hinge parts 17 are provided at a lower end of the display unit 12.

The display unit 12 is rotated between a closed position and an open position, with the hinge parts 17 serving as fulcrums. In the closed position, the display unit 12 lies on the main unit 11. In the open position, the display unit 12 stands from the rear end of the main unit 11.

The display unit 12 includes a display housing 18 which has a flat box shape, and a display module 19. The display module 19 is, for example, a liquid crystal display of 15 inches. The display module 19 is contained in the display housing 18. The display module 19 includes a screen which displays images. The screen of the display module 19 is exposed to the outside through an opening provided in the display housing 18.

As illustrated in FIG. 2, the port replicator 1 comprises a housing 21, a board 22, a second connector 23, a pair of projecting parts 24, an eject lever 25, a plurality of terminals 26, a positioning part 27, and positioning indicators 28. The second connector 23 is an example of a connecting part.

The housing 21 includes a rectangular placing part 31, and a depressed part 32. The placing part 31 is an upper surface of the housing 21. An apparatus of various types, such as the first portable computer 2, is placed on the placing part 31. The placing part 31 is not limited to a flat surface, but may include a plurality of depressions and projections. The placing part 31 supports an apparatus which is connected to the port replicator 1 in a state of being inclined forward. As illustrated in FIG. 2, a position where the apparatus is supported is not all of the area of the upper surface of the housing 21, but part of the area.

The depressed part 32 is provided in a center part of the placing part 31, and extends in a longitudinal direction of the placing part 31. The depressed part 32 is, for example, a depression in which an additional battery attached to the first portable computer 2 is contained. By virtue of the depressed part 32, the rear end of the first portable computer 2 may be easily held by hand.

As illustrated by the broken line in FIG. 2, the board 22 is contained in the housing 21. The board 22 is a circuit board which is connected to the terminals 26. The terminals 26 are for example, a USB connector, an RGB connector, and a power supply terminal. The terminals 26 are provided at the rear end part 21a of the housing 21.

The second connector 23 is provided to project from the placing part 31. The second connector 23 is disposed closer to the front end part 21c of the housing 21 and in front of the depressed part 32. The second connector 23 is connected to the board 22 inside the housing 21.

The second connector 23 is fitted with the first connector 15 of the first portable computer 2, and thereby connected to the first portable computer 2. Thereby, the board 22 is electrically connected to the first portable computer 2. The second connector 23 is used not only for the first portable computer 2, but common to apparatuses of various types.

The second connector 23 is located in almost the center part in a width direction of the placing part 31. Therefore, the first portable computer 2 which is connected to the second connector 23 is located closer to the right end part 21d of the housing 21, as illustrated in FIG. 2.

The projecting parts 24 are provided to project from the placing part 31. The projecting parts 24 are arranged on either side of the second connector 23. The projecting parts 24 are fitted into the two holes provided at the bottom surface of the main unit 11. Each of the projecting parts 24 has a movable hook which is engaged with the first portable computer 2.

The eject lever 25 is provided at the right end of the rear end part 21a of the housing 21. Since the first portable computer 2 is located closer to the right end part 21d of the housing 21, the eject lever 25 is close to the user.

Inside the housing, the eject lever 25 is coupled to the hooks of the projecting parts 24 and an eject pin of the placing part 31. When the eject lever 25 is operated, the first portable computer 2 is disengaged from the hooks of the projecting parts 24, and the eject pin pushes up the first portable computer 2. Thereby, the second connector 23 comes out of the first connector 15, and the first portable computer 2 is disconnected from the port replicator 1.

The positioning part 27 includes four first movable parts 35A, 35B, 35C, and 35D, and two second movable parts 36A and 36B. Each of the first movable parts 35A, 35B, 35C, and 35D and the second movable parts 36A and 36B is provided in the placing part 31.

Each of the first movable parts 35A, 35B, 35C, and 35D and the second movable parts 36A and 36B is formed in a rectangular plate shape. The placing part 31 is provided with a plurality of slits 38 which receive the first movable parts 35A, 35B, 35C, and 35D, and the second movable parts 36A and 36B. An end part of each of the first movable parts 35A, 35B, 35C, and 35D, and the second movable parts 36A and 36B is rotatably attached to the housing 21 inside the slit 38.

The first movable parts 35A and 35B are arranged in the vicinity of the rear end part 21a of the housing 21. The first movable parts 35A and 35B are provided such that they are rotatable along the rear edge part 2a of the first portable computer 2. The first movable parts 35A and 35B are provided to avoid the terminals 16 of the first portable computer 2.

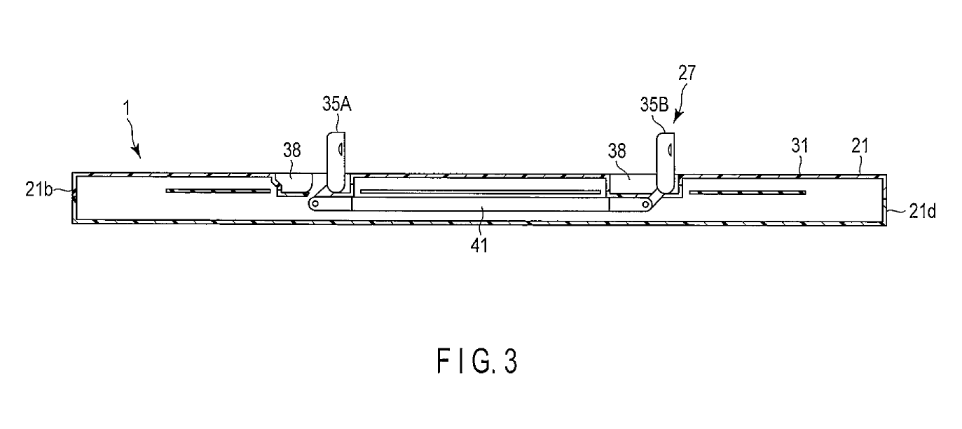

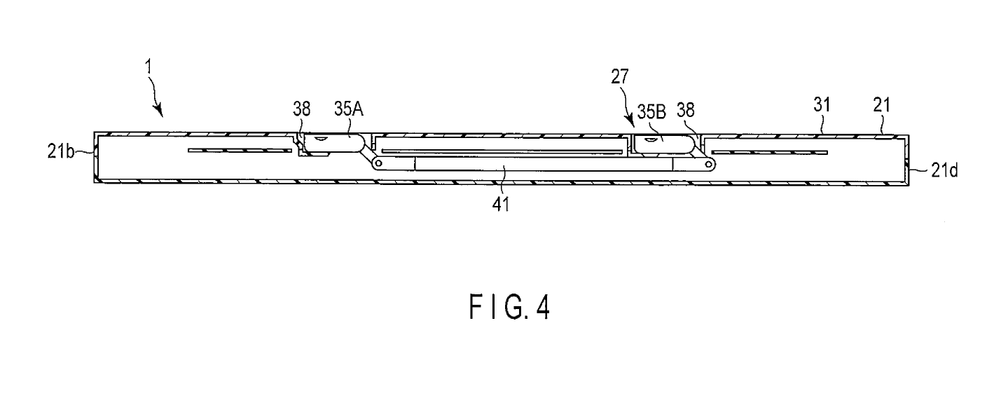

FIG. 3 is a cross-sectional view of the port replicator 1, which is taken along line F3-F3 of FIG. 2. FIG. 4 is a cross-sectional view of the port replicator 1 in the state where the first movable parts 35A and 35B are concealed.

The first movable parts 35A and 35B are rotated, and thereby movable between a first position where the movable parts project from the placing part 31 as illustrated in FIG. 3 and a second position where the movable parts are concealed inside the placing part 31 as illustrated in FIG. 4. In the second position, the first movable parts 35A and 35B are contained in the respective slits 38, and extend in a direction running along the rear edge part 2a of the first portable computer 2. In the same manner, the first movable parts 35C and 35D are rotatable and thereby movable between the first position and the second position.

The first movable parts 35A and 35B are coupled to each other by a link mechanism 41 inside the housing 21. When the first movable part 35A is rotated, the first movable part 35B is also rotated together. In the same manner, the first movable part 35C and the first movable part 35D are coupled by a link mechanism, and rotated in cooperation with each other.

As illustrated in FIG. 1, when the port replicator 1 is connected with the first portable computer 2, the first movable parts 35A and 35B are arranged in the first position, and the first movable parts 35C and 35D are arranged in the second position. In this state, the first movable parts 35A and 35B are adjacent to the rear edge part 2a of the first portable computer 2. Therefore, the first movable parts 35A and 35B guide the first portable computer 2 to a position where the first portable computer 2 is to be connected to the port replicator 1, in a depth direction of the placing part 31. In other words, the first movable parts 35A and 35B project from the placing part 31, in places where the first portable computer 2 is guided to the position where the first portable computer 2 is to be connected to the second connector 23. The places are an example of a first place. In other words, the first portable computer 2 is guided to a position where the first portable computer 2 is to be connected to the second connector 23, by the first movable parts 35A and 35B which project from the placing parts 31.

The first movable parts 35C and 35D are arranged in positions of the placing part 31, which are inner than the first movable parts 35A and 35B, and interposed between the depressed part 32 and the first movable parts 35A and 35B. The first movable parts 35C and 35D are provided such that they are rotatable in parallel with the first movable parts 35A and 35B.

The second movable part 36A is disposed in the vicinity of the left end part 21b of the housing 21. The second movable part 36A is provided such that the second movable part 36A is rotatable along the left edge part 2b of the first portable computer 2. The second movable part 36A is disposed to avoid the terminals of the first portable computer 2.

The second movable part 36B is disposed in a part of the placing part 31, which is inner than the second movable part 36A, and interposed between the second movable part 36A and the depressed part 32. The second movable part 36B is provided such that the second movable part 36B is rotatable in parallel with the second movable part 36A.

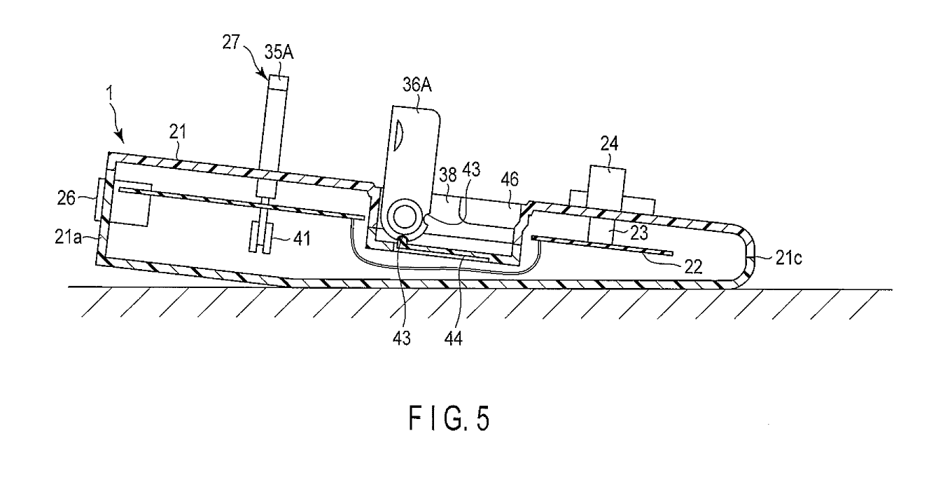

FIG. 5 is a cross-sectional view of the port replicator 1, taken along line F5-F5 of FIG. 2. The second movable part 36A is rotated, and thereby movable between a first position where the second movable part 36A projects from the placing part 31 as illustrated in FIG. 5, and a second position where the second movable part 36A is concealed inside the placing part 31. In the second position, the second movable part 36A is contained in the slit 38, and extends in a direction running along the left edge part 2b of the first portable computer 2. In the same manner, the second movable part 36B is rotated and movable between the first position and the second position.

The second movable part 36A is rotatable independently of the first movable parts 35A, 35B, 35C, and 35D. In the same manner, the second movable part 36B is rotatable independently of the first movable parts 35A, 35B, 35C, and 35D.

As illustrated in FIG. 1, when the port replicator 1 is connected with the first portable computer 2, the second movable part 36A is disposed in the first position, and the second movable part 36B is disposed in the second position. In this state, the second movable part 36A is adjacent to the left edge part 2b of the first portable computer 2. Therefore, the second movable part 36A guides the first portable computer 2 to a position where the first portable computer 2 is connected to the port replicator 1, in the width direction of the placing part 31. In other words, the second movable part 36A projects from the placing part 31 in a place where the first portable computer 2 is guided to the position where the first portable computer 2 is to be connected to the second connector 23. The place is an example of the first place. In other words, the first portable computer 2 is guided to a position where the first portable computer 2 is to be connected to the second connector 23, by the second movable part 36A which projects from the placing parts 31.

As illustrated in FIG. 5, two depressions 43 are provided in an edge of each of the second movable parts 36A and 36B. On the other hand, an engaging piece 44 is provided in each of the slits 38 in which the second movable parts 36A and 36B are contained. The engaging piece 44 is formed like a cantilever at the bottom of the slit 38, and can be elastically engaged with one of the depressions 43 in the slit. Each engaging piece 44 is engaged with one of the depressions 43 when the second movable parts 36A and 36B are rotated to the first position and the second position. Thereby, a click occurs when the second movable parts 36A and 36B are rotated.

As illustrated in FIG. 1, the placing part 31 is provided with two grooves 46. One groove 46 is provided to extend over the two slits 38 in which the first movable parts 35A and 35C are contained, and opened to the depressed part 32. The other groove 46 is provided to extend over the two slits 38 in which the second movable parts 36A and 36B are contained, and opened to the left end part 21b of the housing 21. Each of the grooves 46 has a width sufficient to receive a finger.

The positioning indicators 28 are provided to have a line shape by being, for example, printed on the placing part 31. The positioning indicators 28 are located closer to the rear end part 21a of the housing 21 than the first movable parts 35A and 35B.

The port replicator 1 is connected with apparatuses of various types as follows.

When the port replicator 1 is connected with the first portable computer 2, the first movable part 35A is moved to the first position, and the first movable part 35C is moved to the second position. When the first movable part 35A is moved to the first position, the first movable part 35B is also moved to the first position together. When the first movable part 35C is moved to the second position, the first movable part 35D is moved to the second position together. When a finger of the user is put into the groove 46 and a nail of the user is hooked on the depression provided in the first movable part 35A, the work of moving the first movable part 35A can be easily performed.

In addition, the second movable part 36A is moved to the first position, and the second movable part 36B is moved to the second position. When a finger of the user is put into the groove 46 and a nail of the user is hooked on the depression provided in the second movable part 36A, the work of moving the second movable part 36A can be easily performed.

Next, the rear end part 2a of the first portable computer 2 is made to abut on the first movable parts 35A and 35B, and the left end part 2b is made to abut on the second movable part 36A. The rear end part 2a of the first portable computer 2 may be the rear end of the main unit 11, or the back surface of the display unit 12.

When the first portable computer 2 abuts on the first movable parts 35A and 35B and the second movable part 36A, the first connector 15 is guided onto the second connector 23. When the first portable computer 2 is placed on the placing part 31 in this state, the projecting parts 24 are fitted into the holes of the main unit 11, and the second connector 23 is fitted with the first connector 15. Thereby, the port replicator 1 is connected with the first portable computer 2.

The first portable computer 2 may not be made to abut on the first movable parts 35A and 35B and the second movable part 36A. The port replicator 1 may be connected with the first portable computer 2, while the user views the first movable parts 35A and 35B and the second movable part 36A as marks.

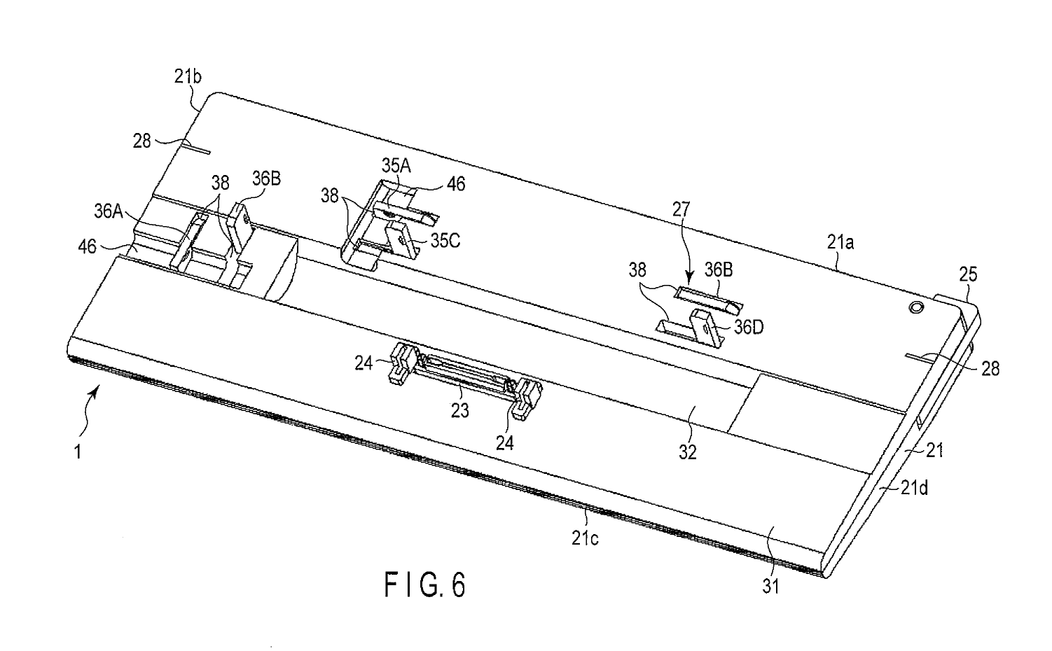

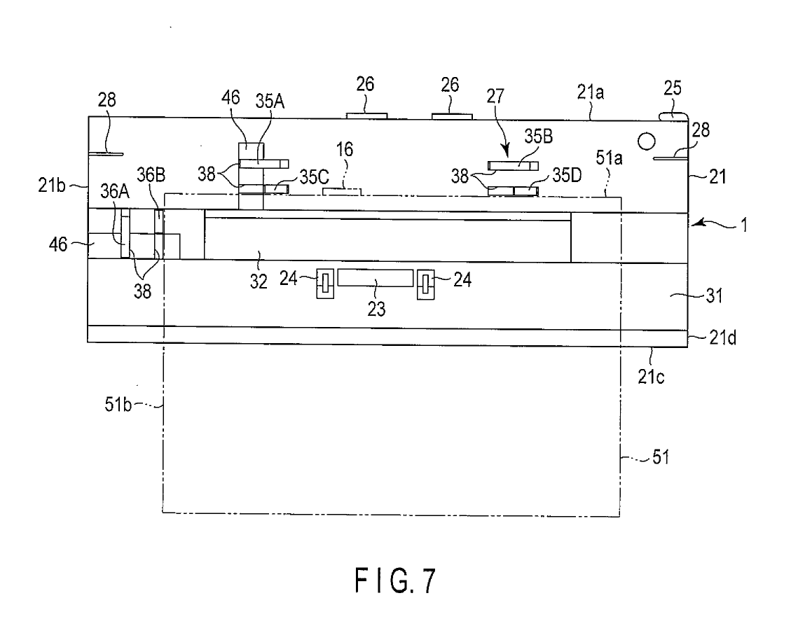

FIG. 6 is a perspective view of the port replicator 1 in a state where the first movable parts 35C and 35D and the second movable part 36B are moved to the first position. FIG. 7 is a plan view of the port replicator 1 which is connected to a second portable computer 51.

The second portable computer 51 is an example of another apparatus which has a size different from that of the apparatus. The second portable computer 51 includes, for example, a display module of 10 inches. The second portable computer 51 is smaller than the first portable computer 2. The second portable computer 51 includes a first connector 15 and terminals 16, like the first portable computer 2.

As illustrated in FIG. 6, when the port replicator 1 is connected with the second portable computer 51, the first movable part 35A is moved to the second position, and the first movable part 35C is moved to the first position. When the first movable part 35A is moved to the second position, the first movable part 35B is also moved to the second position together. When the first movable part 35C is moved to the first position, the first movable part 35D is moved to the first position together. In addition, the second movable part 36A is moved to the second position, and the second movable part 36B is moved to the first position.

Next, as illustrated in FIG. 7, a rear end part 51a of the second portable computer 51 is made to abut on the first movable parts 35C and 35D, and a left end part 51b is made to abut on the second movable part 36B.

When the second portable computer 51 abuts on the first movable parts 35C and 35D and the second movable part 36B, the first connector 15 of the second portable computer 51 is guided onto the second connector 23. When the second portable computer 51 is placed on the placing part 31 in this state, the second connector 23 is fitted with the first connector 15. Thereby, the port replicator 1 is connected with the second portable computer 51.

The second portable computer 51 may not be made to abut on the first movable parts 35C and 35D and the second movable part 36B. The port replicator 1 may be connected with the second portable computer 51, while the user views the first movable parts 35C and 35D and the second movable part 36B as marks.

When the port replicator 1 is connected with the second portable computer 51, the first movable parts 35C and 35D are adjacent to the rear edge part 51a of the second portable computer 51. Therefore, the first movable parts 35C and 35D guide the second portable computer 51 to a position where the second portable computer 51 is connected with the port replicator 1, in the depth direction of the placing part 31. In other words, the first movable parts 35C and 35D project from the placing part 31, in places where the second portable computer 51 is guided to the position where the second portable computer 51 is connected to the second connector 23. The places are an example of the second place. In other words, the second portable computer 51 is guided to the position where the second portable computer 51 is connected to the second connector 23, by the first movable parts 35C and 35D which project from the placing part 31.

In the same manner, when the port replicator 1 is connected with the second portable computer 51, the second movable part 36B is adjacent to the left edge part 51b of the second portable computer 51. Therefore, the second movable part 36B guides the second portable computer 51 to a position where the second portable computer 51 is connected with the port replicator 1, in the width direction of the placing part 31. In other words, the second movable part 36B projects from the placing part 31, in a place where the second portable computer 51 is guided to the position where the second portable computer 51 is connected to the second connector 23. The place is an example of the second place. In other words, the second portable computer 51 is guided to the position where the second portable computer 51 is connected to the second connector 23, by the second movable part 36B which projects from the placing part 31.

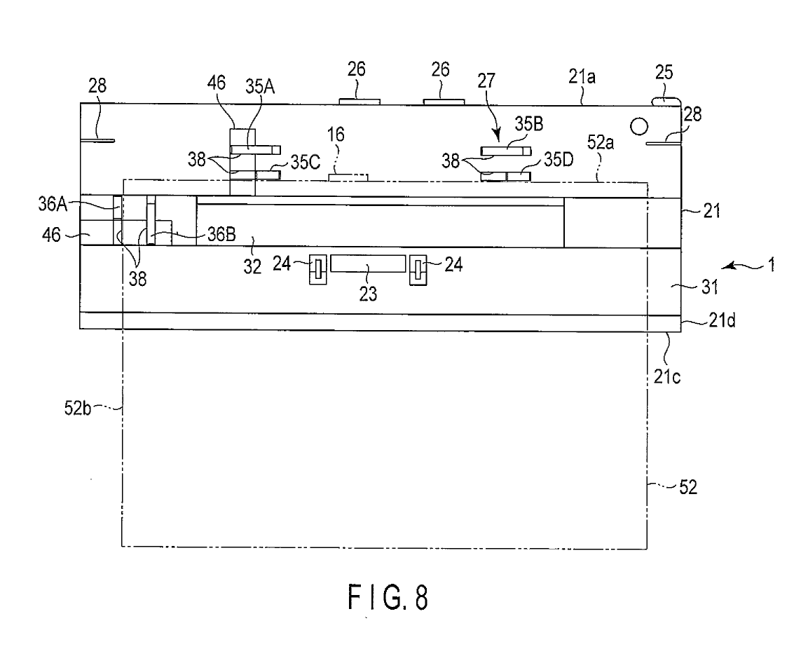

FIG. 8 is a plan view of the port replicator 1 which is connected to a third portable computer 52. The third portable computer 52 is an example of another apparatus which has a different size from the apparatus. The third portable computer 52 includes, for example, a display module of 13 inches. The third portable computer 52 is smaller than the first portable computer 2, and larger than the second portable computer 51. The third portable computer 52 includes a first connector 15 and terminals 16, like the first portable computer 2.

As illustrated in FIG. 8, when the port replicator 1 is connected with the third portable computer 52, the first movable parts 35A and 35B are moved to the second position, and the first movable parts 35C and 35D are moved to the first position. In addition, the second movable part 36A is moved to the first position, and the second movable part 36B is moved to the second position.

Next, a rear end part 52a of the third portable computer 52 is made to abut on the first movable parts 35C and 35D, and a left end part 52b is made to abut on the second movable part 36A.

When the third portable computer 52 abuts on the first movable parts 35C and 35D and the second movable part 36A, the first connector 15 of the third portable computer 52 is guided onto the second connector 23. When the third portable computer 52 is placed on the placing part 31 in this state, the second connector 23 is fitted with the first connector 15. Thereby, the port replicator 1 is connected with the third portable computer 52.

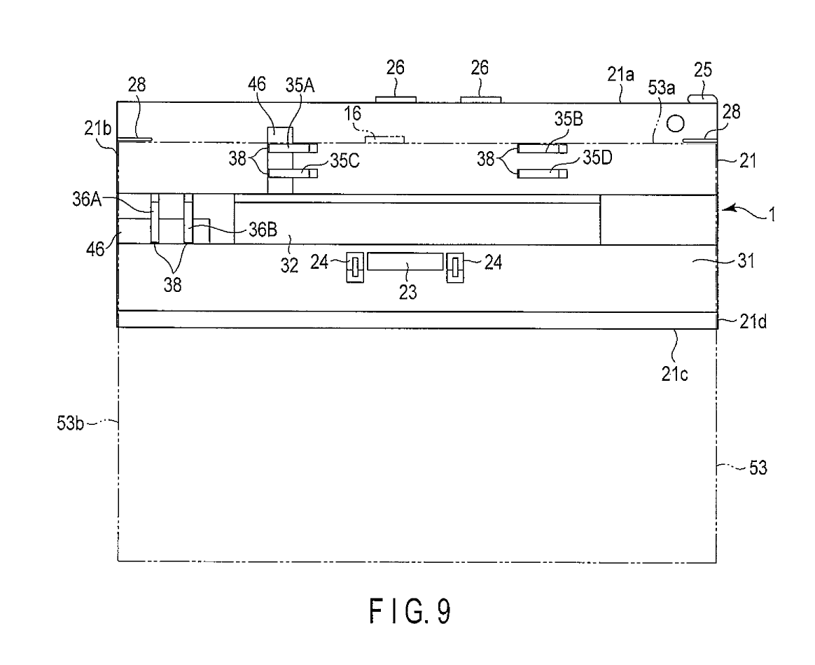

FIG. 9 is a plan view of the port replicator 1 which is connected to a fourth portable computer 53. The fourth portable computer 53 is an example of a different apparatus which has a different size from the apparatus. The fourth portable computer 53 includes, for example, a display module of 17 inches. The fourth portable computer 53 is larger than the first portable computer 2. The fourth portable computer 53 includes a first connector 15, like the first portable computer 2.

As illustrated in FIG. 9, when the port replicator 1 is connected with the fourth portable computer 53, the first movable parts 35A, 35B, 35C, and 35D, and the second movable parts 36A and 36B are moved to the second position.

Next, a rear edge part 53a of the fourth portable computer 53 is moved to a position which is aligned with the positioning indicators 28. In addition, a left edge part 53b of the fourth portable computer 53 is moved to a position which is aligned with the left end part 21b of the housing 21.

When the fourth portable computer 53 is aligned with the positioning indicators 28 and the left end part 21b of the housing 21, the first connector 15 of the fourth portable computer 53 is guided onto the second connector 23. When the fourth portable computer 53 is placed on the placing part 31 in this state, the second connector 23 is fitted with the first connector 15. Thereby, the port replicator 1 is connected with the fourth portable computer 53.

When the port replicator 1 is connected with the fourth portable computer 53, the positioning indicators 28 are aligned with the rear edge part 53a of the fourth portable computer 53. In other words, the positioning indicators 28 are provided in the placing part 31, in places where they guide the fourth portable computer 53 to a position where the fourth portable computer 53 is connected to the second connector 23. In other words, the fourth portable computer 53 is guided to the position where the fourth portable computer 53 is connected to the second connector 23, by the positioning indicators 28.

According to the port replicator 1 having the above structure, the first and second movable parts 35A, 35B, and 36A project from the placing part 31, in the places where they guide the first portable computer 2 to the position where the first portable computer 2 is connected to the second connector 23. On the other hand, the first and second movable parts 35C, 35D and 36B project from the placing part 31, in the places where they guide the second portable computer 51 to the position where the second portable computer 51 is connected to the second connector 23. As described above, since the first movable parts 35A, 35B, 35C, and 35D and the second movable parts 36A and 36B can project from a plurality of places, it is possible to guide apparatuses of various types to a position where the apparatuses are connected to the second connector 23. In addition, since one port replicator 1 can be compatible with apparatuses of a plurality of types, the degree of freedom of design of the apparatuses such as the first portable computer 1 is increased.

The positioning part 27 can guide the apparatus with a small number of parts of simple shape and small size, such as the first movable parts 35A, 35B, 35C, and 35D and the second movable parts 36A and 36B. Therefore, the manufacturing cost of the port replicator 1 is reduced.

The apparatus such as the first portable computer 2 is made to abut on the first movable parts 35A, 35B, 35C, and 35D and the second movable parts 36A and 36B, and thereby the apparatus can be guided. Since positioning can be intuitively performed as described above, the work of connecting the port replicator 1 with the apparatus such as the first portable computer 2 can be easily performed.

Each of the first movable parts 35A, 35B, 35C, and 35D and the second movable parts 36A and 36B can be moved between the first position where it projects from the placing part 31 and the second position where it is concealed in the placing part 31. Thereby, even when the apparatus is placed on the first movable parts 35A, 35B, 35C, and 35D and the second movable parts 36A and 36B, the first movable parts 35A, 35B, 35C, and 35D and the second movable parts 36A and 36B are moved to the second position, and thereby they are prevented from interfering with the apparatus.

The first movable parts 35A, 35B, 35C, and 35D are rotated along the rear edge part 2a of the first portable computer 2. The second movable parts 36A and 36B are rotated along the left edge part 2b of the first portable computer 2. Specifically, the first movable parts 35A, 35B, 35C, and 35D and the second movable parts 36A and 36B are rotated in a state of being inclined by 90° with respect to a direction in which the apparatus abuts on them. Thereby, the first movable parts 35A, 35B, 35C, and 35D and the second movable parts 36A and 36B are prevented from being displaced to the second position or broken, by the apparatus such as the first portable computer 2 which abuts on the first movable parts 35A, 35B, 35C, and 35D and the second movable parts 36A and 36B.

The first movable parts 35A and 35B are rotated together, and the first movable parts 35C and 35D are rotated together. Therefore, it is unnecessary to operate the first movable parts 35B and 35D, and positioning of the apparatus is facilitated.

The second movable parts 36A and 36B are rotatable independently of the first movable parts 35A, 35B, 35C, and 35D. Thereby, it is possible to guide the apparatuses of a plurality of types, such as the second portable computer 51 and the third portable computer 52, the positions of the first connectors 15 of which are the same in the depth direction but different in the width direction.

The first movable parts 35A, 35B, 35C, and 35D and the second movable parts 36A and 36B are arranged to avoid terminals of the apparatus, such as the terminals 16 of the first portable computer 2. Thereby, even when an apparatus such as the first portable computer 2 is connected to the port replicator 1, the terminals of the apparatus can be used.

The positioning indicators 28 are provided to be aligned with the rear edge part 53a of the fourth portable computer 53 which is connected to the port replicator 1. Thereby, it is possible to guide the apparatus such as the fourth portable computer 53, even in a position where the first movable parts 35A, 35B, 35C, and 35D and the second movable parts 36A and 36B are difficult to provide due to interference between parts.

In the above embodiment, the second movable parts 36A and 36B are adjacent to the left edge part of the apparatus such as the first portable computer 2. However, the embodiment is not limited to this structure, and the second movable parts 36A and 36B may be adjacent to the right edge part or other parts, or may be adjacent to both the left edge part and the right edge part.

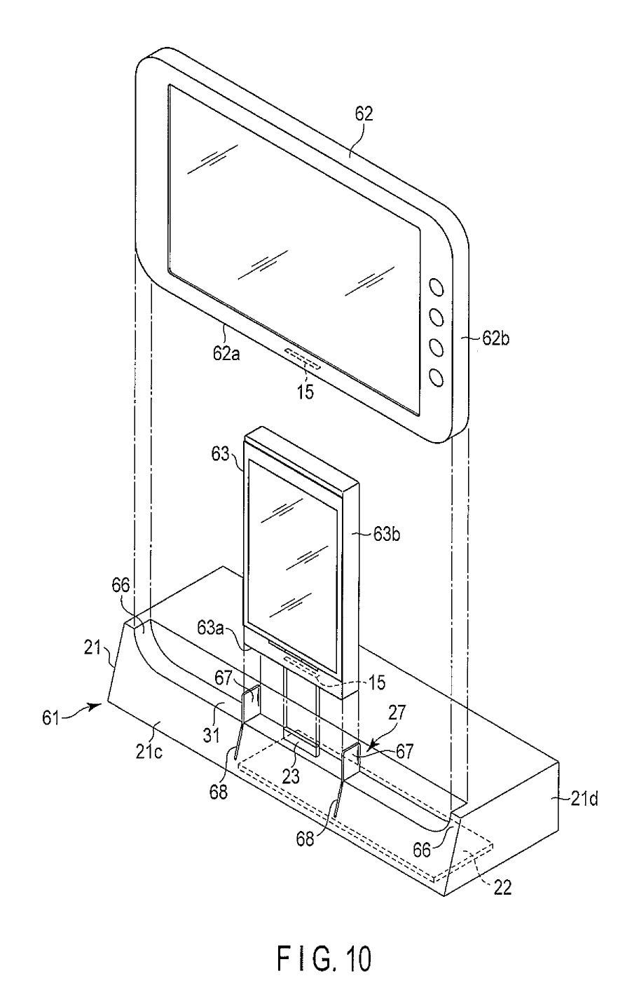

Next, a second embodiment will be explained with reference to FIG. 10. In embodiments disclosed hereinafter, constituent elements which have the same functions as those of the port replicator 1 of the first embodiment and the first portable computer 2 are denoted by the same respective reference numerals. In addition, part of or all the explanation of the constituent elements may be omitted.

FIG. 10 is a perspective view illustrating a cradle 61, a slate computer 62, and a mobile phone 63 according to the second embodiment. The cradle 61 is an example of an electronic apparatus. The slate computer 62 is an example of one apparatus. The mobile phone 63 is an example of another apparatus which has a different size from the apparatus.

As illustrated in FIG. 10, the slate computer 62 is formed in a rectangular plate shape. A bottom edge part 62a of the slate computer 62 is provided with a first connector 15. The bottom edge part 62a of the slate computer 62 is longer than a side edge part 62b thereof.

The mobile phone 63 is formed in a rectangular plate shape. The mobile phone 63 is smaller than the slate computer 62. In the same manner as the slate computer 62, a bottom edge part 63a of the mobile phone 63 is provided with a first connector 15. The bottom edge part 63a of the mobile phone 63 is shorter than a side edge part 63b thereof.

The cradle 61 comprises a housing 21, a board 22, a second connector 23, and a positioning part 27. The housing 21 includes a placing part 31 which is formed in a cut shape. A plurality of types of apparatuses such as the slate computer 62 and the mobile phone 63 are placed on the placing part 31.

The second connector 23 is provided in almost a center part of the placing part 31. The second connector 23 is connected to the first connector 15 of each of the slate computer 62 and the mobile phone 63 in common.

The positioning part 27 includes a pair of side walls 66, and a pair of movable parts 67. The side walls 66 are provided at both ends of the placing part 31, and are continuous with the placing part 31. When the cradle 61 is connected with the slate computer 62, the side walls 66 are adjacent to the side edge parts 62b of the slate computer 62. Therefore, the side walls 66 guide the slate computer 62 to a position where the slate computer 62 is connected to the cradle 61, in a width direction of the placing part 31. In other words, the side walls 66 are provided in the placing part 31, in places where they guide the slate computer 62 to the position where the slate computer 62 is connected to the second connector 23.

The movable parts 67 are provided in the placing part 31. Each of the movable parts 67 is formed in a rectangular plate shape. A pair of slits 68 to contain the respective movable parts 67 are provided to extend from the placing part 31 to a front end part 21c of the housing 21. End parts of the movable parts 67 are rotatably attached to the housing 21 inside the respective slits 68.

The movable parts 67 are arranged in parts of the placing part 31, which are inner than the side walls 66. The movable parts 67 are rotatable along the side edge parts 63b of the mobile phone 63. Each of the movable parts 67 is rotated and thereby movable between a first position where it projects from the placing part 31 and a second position where it is concealed in the placing part 31. In the second position, the movable parts 67 are contained in the slits 68. The movable parts 67 are coupled to each other inside the housing 21, and are rotated together.

When the cradle 61 is connected with the mobile phone 63, the movable parts 67 are arranged in the first position. In this state, the movable parts 67 are adjacent to the side edge parts 63b of the mobile phone 63. Therefore, the movable parts 67 guide the mobile phone 63 to a position where the mobile phone 63 is connected to the second connector 23, in the width direction of the placing part 31. In other words, the movable parts 67 project from the placing part 31, in places where they guide the mobile phone 63 to the position where the mobile phone 63 is connected to the second connector 23. When the cradle 61 is connected with the slate computer 62, the movable parts 67 are moved to the second position.

According to the cradle 61 having the above structure, it is possible to guide a plurality of types of apparatuses such as the slate computer 62 and the mobile phone 63 to the position where they are connected to the second connector 23, in the same manner as the port replicator 1 of the first embodiment.

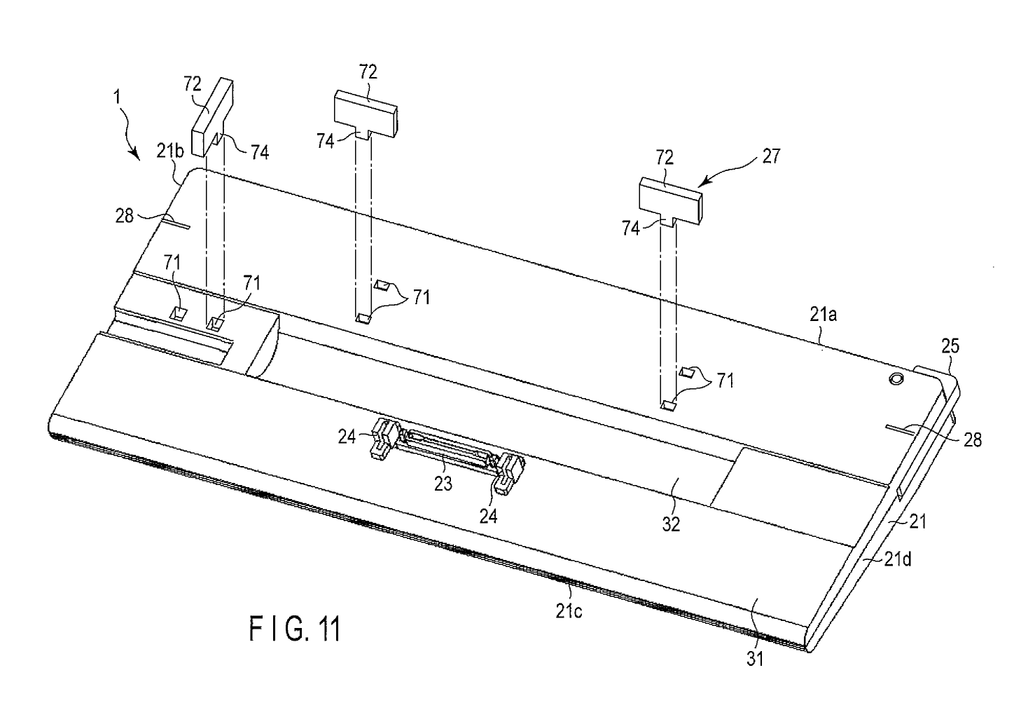

Next, a third embodiment will be explained hereinafter with reference to FIG. 11. FIG. 11 is a perspective view of a port replicator 1 according to the third embodiment. As illustrated in FIG. 11, a placing part 31 is provided with a plurality of fitting parts 71 which are holes.

A positioning part 27 includes a plurality of blocks 72. The number of the blocks 72 is smaller than the number of the fitting parts 71. Each of the blocks 72 includes an inserting part 74. The inserting parts 74 are detachably fitted into the fitting parts 71, and thereby the blocks 72 project from the placing part 31.

Each of the blocks 72 is selectively fitted with one of the fitting parts 71. Therefore, the blocks 72 can project in a plurality of places from the placing part 31.

When the port replicator 1 is connected with a first portable computer 2, the blocks 72 project from the placing part 31, in places where they guide the first portable computer 2 to a position where the first portable computer 2 is connected to the second connector 23. The places are an example of the first place.

When the port replicator 1 is connected with a second portable computer 51, the blocks 72 project from the placing part 31, in places where they guide the second portable computer 51 to a position where the second portable computer 51 is connected to the second connector 23. The places are an example of the second place.

According to the port replicator 1 having the above structure, the positioning part 27 includes the blocks 72 which are detachably fitted with the fitting parts 71. Thereby, the structure of the port replicator 1 is more simplified than the first embodiment using the rotatably attached first movable parts 35A, 35B, 35C, 35D and the second movable parts 36A and 36B.

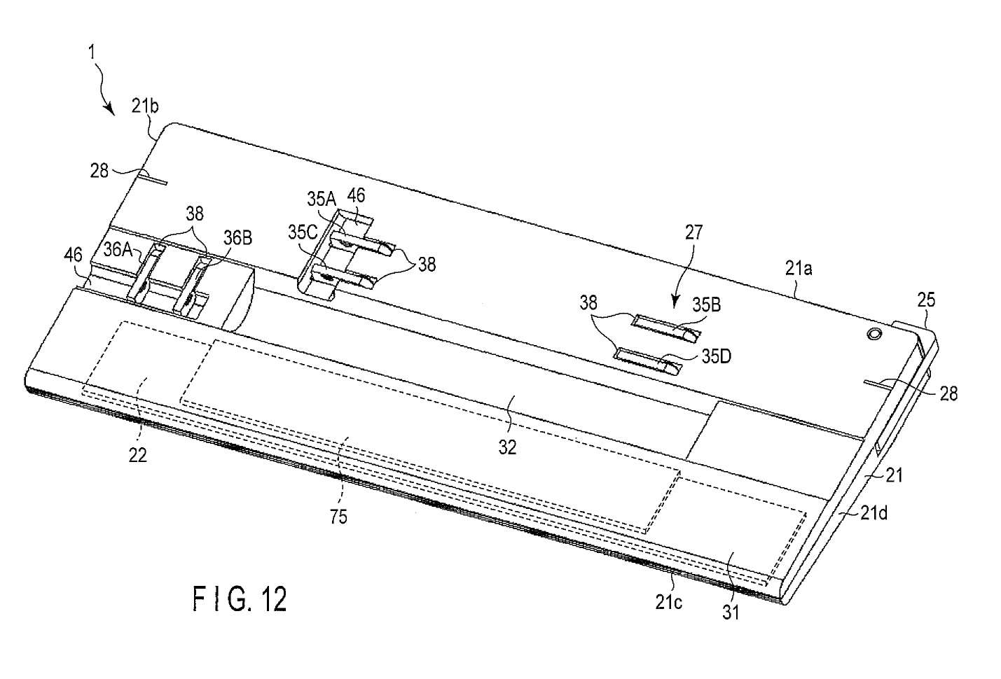

Next, a fourth embodiment will be explained hereinafter with reference to FIG. 12. FIG. 12 is a perspective view of a port replicator 1 according to the fourth embodiment. As illustrated by a broken line in FIG. 12, the port replicator 1 includes a wireless power supply part 75.

The wireless power supply part 75 is contained in a housing 21, and connected to a board 22. The wireless power supply part 75 includes a coil, and supplies power to, for example, a first portable computer 2 placed on the placing part 31 by electromagnetic induction.

First movable parts 35A and 35B guide the first portable computer 2 to a position where electric power to be supplied to the first computer 2 is maximum, in a depth direction of the placing part 31. In other words, the first movable parts 35A and 35B project from the placing part 31, in places where they guide the first portable computer 2 to the position where the electric power to be supplied to the first portable computer 2 is maximum. In the same manner, a second movable part 36A projects from the placing part 31, in a place where it guides the first portable computer 2 to the position where the electric power to be supplied to the first portable computer 2 is maximum. The places are an example of the first place.

On the other hand, first movable parts 35C and 35D project from the placing part 31, in places where they guide, for example, the second portable computer 51 to the position where the electric power to be supplied to the second portable computer 51 is maximum. In the same manner, a second movable part 36B projects from the placing part 31, in a place where it guides the second portable computer 51 to the position where the electric power to be supplied to the second portable computer 51 is maximum. The places are an example of the second place.

According to the port replicator 1 having the above structure, the positioning part 27 can guide the apparatuses of various types, even when the port replicator 1 is connected with the apparatuses in a non-contact manner. The non-contact connection is not limited to wireless power supply, but may be, for example, wireless communication.

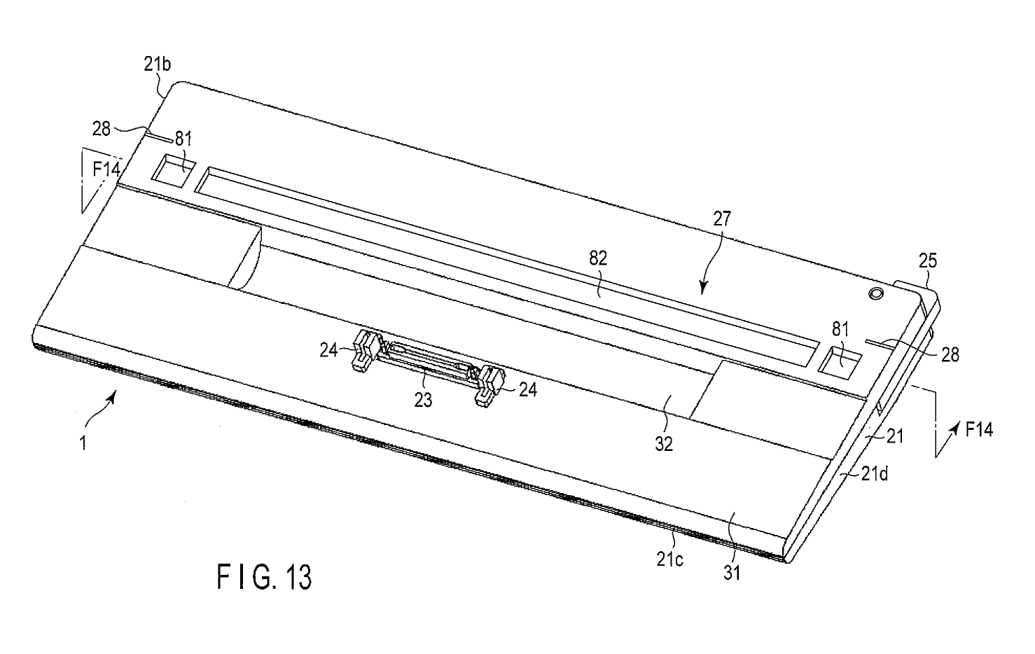

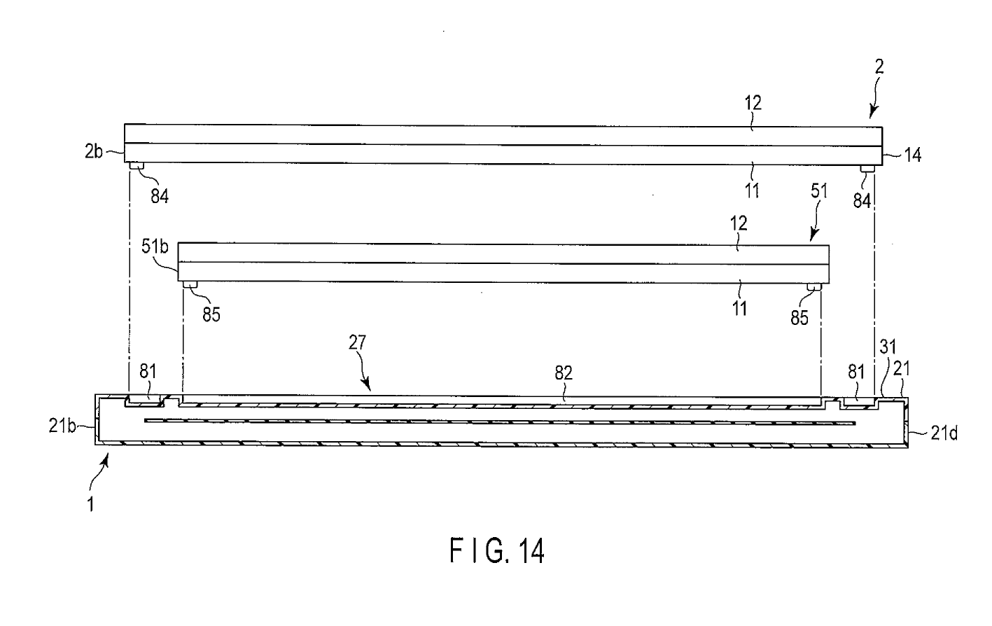

Next, a fifth embodiment will be explained hereinafter with reference to FIG. 13 and FIG. 14. FIG. 13 is a perspective view illustrating a port replicator 1 according to the fifth embodiment. FIG. 14 is a cross-sectional view of the port replicator 1, taken along line F14-F14 of FIG. 13.

As illustrated in FIG. 13, a positioning part 27 includes a pair of first engaging parts 81, and a second engaging part 82. The first engaging parts 81 and the second engaging part 82 are an example of an engaging part.

The second engaging part 82 is a depression which is provided in a placing part 31. The second engaging part 82 extends in a width direction of the placing part 31. The second engaging part 82 is located between a rear end part 21a of a housing 21 and a depressed part 32.

The first engaging parts 81 are depressions provided in the placing part 31. The first engaging parts 81 are arranged on either side of the second engaging part 82. One first engaging part 81 is closer to a left end part 21b of the housing 21 than the second engaging part 82 is. The other first engaging part 81 is closer to a right end part 21d than the second engaging part 82 is.

As illustrated in FIG. 14, a first portable computer 2 includes a pair of legs 84. The legs 84 are an example of a projection. Each of the legs 84 is provided on a bottom surface of the first portable computer 2, and provided with nonskid rubber.

A second portable computer 51 includes a pair of legs 85. The legs 85 are an example of a projection. Each of the legs 85 is provided on a bottom surface of the second portable computer 51, and provided with nonskid rubber.

When the port replicator 1 is connected with the first portable computer 2, outer edge parts of the legs 84 are engaged with respective inner edges of the first engaging parts 81. Therefore, the first engaging parts 81 guide the first portable computer 2 to a position where the first portable computer 2 is connected to the port replicator 1. In other words, the first engaging parts 81 are provided in the placing part 31, in places where they guide the first portable computer 2 to the position where the first portable computer 2 is connected to a second connector 23. The places are an example of the first place.

When the port replicator 1 is connected with the second portable computer 51, outer edge parts of the legs 85 are engaged with respective inner edges of the second engaging part 82. Therefore, the second engaging part 82 guides the second portable computer 51 to a position where the second portable computer 51 is connected to the port replicator 1. In other words, the second engaging part 82 is provided in the placing part 31, in a place where it guides the second portable computer 51 to the position where the second portable computer 51 is connected to the second connector 23. The place is an example of the second place.

According to the port replicator 1 having the above structure, the first engaging parts 81 and the second engaging part 82, which are depressions provided in the placing part 31, can guide apparatuses of various types to the position where the apparatuses are connected to the second connector 23. This structure reduces the number of parts of the port replicator 1.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, the place, the shape, and the number of the positioning part 27 are not limited to the disclosed embodiments. The positioning part 27 may be properly disposed in an area in which it guides an apparatus such as the first portable computer 2.

What is claimed is:

1. A docking station comprising:
a housing comprising a placing part;
a connecting part in the placing part, the connecting part configured to connect a first apparatus and a second apparatus; and
a positioning part configured to project from the placing part in a first place and a second place, the positioning part in the first place being adjacent to an edge part of the first apparatus and configured to guide the first apparatus to a position where the first apparatus is connected to the connecting part, the positioning part in the second place being adjacent to an edge part of the second apparatus and configured to guide the second apparatus to a position where the second apparatus is connected to the connecting part, the second apparatus being a different size from the first apparatus.

2. The docking station of claim 1, wherein
the positioning part is configured move between a first position where the positioning part projects from the placing part and a second position where the positioning part is concealed in the placing part.

3. The docking station of claim 2, wherein
the positioning part is configured to rotate along the edge part of the first apparatus, and configured to move between the first position and the second position.

4. The docking station of claim 3, wherein
the positioning part comprises a plurality of first movable parts configured to move between the first position and the second position, and
the first movable parts are configured to move together.

5. The docking station of claim 4, wherein
the positioning part comprises a second movable part configured to move between the first position and the second position independently of the first movable parts.

6. The docking station of claim 5, wherein
the positioning part is configured to be disposed to avoid terminals provided on the first apparatus.

7. The docking station of claim 1, wherein
the placing part comprises a fitting part, and
the positioning part is configured to detachably fit with the fitting part, and configured to project from the placing part.

8. The docking station of claim 1, further comprising:
a positioning indicator in the placing part, the positioning indicator aligned with an edge part of a third apparatus when the third apparatus is connected to the connecting part, the third apparatus being a different size from the first apparatus and the second apparatus.

9. An electronic apparatus comprising:
a housing comprising a placing part;
a board in the housing, the board configured to connect to a first apparatus and a second apparatus; and
a plurality of positioning parts in the placing part in a first place and a second place, the plurality of positioning parts in the first place configured to guide the first apparatus to a position where the first apparatus is connected to the board, and the plurality of positioning parts in the second place configured to guide the second apparatus to a position where the second apparatus is connected to the board, the second apparatus being a different size from the first apparatus.

10. The electronic apparatus of claim 9, wherein
each of the plurality of positioning parts comprises an engaging part configured to engage with a projection on the first apparatus and the second apparatus.
